(19) United States
(12) Patent Application Publication
(10) Pub. No.: US 2026/0140051 A1
(43) Pub. Date: May 21, 2026

(54) INFRARED TRANSMISSION FLOW CELL WITH THERMAL RAMPING CAPABILITY

(71) Applicant: RedShift BioAnalytics, Inc., Boxborough, MA (US)

(72) Inventors: Dennis Merrill, Boxborough, MA (US); Qun Zhong, Boxborough, MA (US); Eugene Ma, Newton, MA (US); Jinhong Kim, Boxborough, MA (US); Shane Triscott, Boxborough, MA (US)

(21) Appl. No.: 19/392,590

(22) Filed: Nov. 18, 2025

Related U.S. Application Data
(60) Provisional application No. 63/721,751, filed on Nov. 18, 2024.

(51) Int. Cl. G01N 21/3577

(52) U.S. Cl. CPC G01N 21/3577; G01N 2201/023; G01N 2201/061

(57) ABSTRACT

A Microfluidic Modulation Spectroscopy (e.g. MMS) system enables measurement of a liquid analyte with a weak absorbance in a prescribed reference solution with a very high absorbance. The method includes alternatively flowing the liquid analyte and the prescribed reference solution through a fluid chamber in a liquid flow cell. The temperature of the analyte can be changed following a predetermined curve while spectral data is being collected. As the temperature of the analyte is increased, outgassing of trapped and dissolved air dissolved in the liquid analyte may be reduced, especially within the interrogation region of the flow cell, by application of a backpressure to the exit line of the flow cell. This is important for proteins, RNA, DNA, and other biomolecules because their structure and function are often temperature dependent. Further, some biological drugs need to be distributed globally and may encounter a range of ambient conditions in shipping.

### PRIORITY

This patent application claims priority from provisional U.S. patent application No. 63/721,751, filed Nov. 18, 2024, entitled, “INFRARED TRANSMISSION FLOW CELL WITH THERMAL RAMPING CAPABILITY,” and naming Dennis Merrill, Qun Zhong, Eugene Ma, Jinhong Kim, and Shane Triscott as inventors, the disclosure of which is incorporated herein, in its entirety, by reference.

### FIELD

Illustrative embodiments of the invention generally relate to using infrared transmission spectroscopy and, more particularly, various embodiments of the invention relate to using infrared transmission spectroscopy to measure biological samples in aqueous solutions.

### BACKGROUND

Microfluidic Modulation Spectroscopy, or MMS, is an ultra-sensitive infrared spectroscopy technique for measuring biological samples in aqueous solutions. This technique has been well established to show as much as 30X improvement in sensitivity and repeatability when measuring proteins in their native formulation. It has shown utility for measuring proteins and nucleic acid (RNA, DNA) structures.

However, using infrared spectroscopy techniques for measuring biological samples in aqueous solutions over large temperature ranges has proven to be difficult due to the generation of bubbles of air and other dissolved gases as the temperature of the aqueous solutions increases.

### SUMMARY OF VARIOUS EMBODIMENTS

In accordance with one embodiment of the invention, a system to measure a liquid analyte with a weak absorbance in a prescribed reference solution with a very high absorbance includes a liquid flow cell, one or more shutoff valves preceding the liquid flow cell, and a vessel following the liquid flow cell. The vessel has airspace above a liquid occupying the vessel. The system further includes an air regulator following the flow cell. The air regulator is configured to provide a back pressure to the liquid flow cell. The liquid is injected into the system at an injection site before the shutoff valves and is moved through the system under pressure provided at the injection site.

The system may further include an infrared light source. The infrared light source may be configured to provide infrared light to be transmitted through the liquid flow cell. The liquid flow cell may transmit infrared light.

The system may further include a system controller.

The air regulator may be configured to provide a fixed amount of pressure. The air regulator may be configured to be dynamically adjusted by the system controller. The dynamically-adjusted air regulator may provide a backpressure on the flow cell between 0 psig and 100 psig inclusive. The dynamically-adjusted air regulator may be controlled by a dynamic pressure controller. The fixed pressure air regulator may provide a backpressure on the flow cell that is settable between 0 psig and 100 psig inclusive.

The fixed pressure air regulator may be configured to be controlled by a closed-loop pressure control system to measure and hold the pressure at the set pressure.

The system may further include at least one inline gas-permeable membrane following the liquid flow cell.

In accordance with another embodiment of the invention, a method to measure a liquid analyte with a weak absorbance in a prescribed reference solution with a very high absorbance including alternatively flowing the liquid analyte and the prescribed reference solution through a fluid chamber in a liquid flow cell. The method further includes restricting flow of an output of the liquid flow cell along tubing carrying the output of the liquid flow cell. The method further includes emitting an IR light from an IR light source, the IR light being filtered through an optical filter, transmitting the filtered IR light through a sample cell in the fluid chamber to produce a chamber signal, and using a detector having an optical range to detect the chamber signal.

The method may further include directing the output of the flow cell through a restriction in the tubing. The restriction in the tubing may include an inner diameter of the tubing smaller than an inner diameter of the flow cell. The inner diameter of the tubing may be between 1.0 mil and 10 mils. The length of the tubing may be between 1 centimeter and 100 centimeters. The restriction in the tubing may include a proportional flow control valve.

The method may further include directing the output of the flow cell through a virtual restriction. The virtual restriction may include modulating the waste valve duty cycle. The duty cycle may be between 1 HZ and 1000 Hz.

The method may further include controlling the temperature of the liquid flow cell. The temperature of the liquid flow cell may be controlled between about 5 deg. C. and about 100 deg. C. The temperature may be controlled in a ramp rate of between about 0.1 deg. C./minute and 10 deg./min. The temperature ramp rate is about 1 deg. C./minute.

In accordance with another embodiment of the invention, a system to measure a liquid analyte with a weak absorbance in a prescribed reference solution with a very high absorbance includes a tunable optical laser source configured to emit coherent light across a range of wavelengths. The system also includes a liquid flow cell having a sample chamber with a chamber window configured to alternatively receive the liquid analyte and the prescribed reference solution. The system also includes an optical filter positioned between the optical laser source and the liquid flow cell. The optical filter is configured to filter the emitted coherent light prior to being transmitted through the chamber window of the sample chamber to produce a chamber signal. The system also includes a detector having an optical range to detect the chamber signal. The system also includes a restriction along tubing carrying output of the liquid flow cell.

The restriction is the tubing may include a sufficiently small inner diameter such that it adds a prescribed and significant resistance to the flow path. The restriction in the tubing may include a proportional flow control valve.

The system may further include a thermal control device configured to control a temperature of the liquid in the liquid flow cell.

In accordance with another embodiment of the invention, a method to measure a liquid analyte with a weak absorbance in a prescribed reference solution with a very high absorbance includes alternatively flowing the liquid analyte and the prescribed reference solution through a fluid chamber in a liquid flow cell to a waste vessel and pressurizing a headspace of the waste vessel above the waste liquid analyte and prescribed reference solution. The method also includes emitting an infrared (IR) light from an IR light source, the IR light being filtered through an optical filter, transmitting the filtered IR light through a sample cell in the fluid chamber to produce a chamber signal, and using a detector having an optical range to detect the chamber signal.

The method may further include flowing the liquid analyte and the prescribed reference solution through a 3-way valve positioned between fluid chamber in a liquid flow cell and the waste vessel.

The method may further include pressurizing the headspace of the waste vessel through a 3-way valve attached to and in liquid communication with the waste vessel.

The method may further include venting the headspace of the waste vessel through a 3-way valve attached to and in liquid communication with the waste vessel. Pressurizing the headspace may include holding a headspace pressure of greater than atmospheric pressure. The headspace pressure may be held at a of pressure between 0 psig (e.g., pounds per square inch gauge) and 100 psig.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Those skilled in the art should more fully appreciate advantages of various embodiments of the invention from the following “Description of Illustrative Embodiments,” discussed with reference to the drawings summarized immediately below.

FIG. 1A schematically shows an illustration of MMS flow cell according to an embodiment of the invention.

FIG. 1B schematically shows an illustration a “diff-AU” spectrum according to an embodiment of the invention.

FIG. 1C shows a schematic diagram of a low-volume MMS system according to an embodiment of the invention.

FIG. 2 shows the pressure decay of flow cell input line after pressure source is cut off according to an embodiment of the invention.

FIG. 3 shows a sigmoidal curve showing change in differential absorption of 1 mg/ml hen egg white lysozyme in water at 1658 cm-1 according to an embodiment of the invention.

FIG. 4 shows a two-dimensional (2D) spectral heatmap of 1 mg/ml lysozyme in water in response to temperature change according to an embodiment of the invention.

FIG. 5A shows a cross section of one embodiment of a thermally controlled flow cell according to an embodiment of the invention.

FIG. 5B shows a schematic drawing of the thermal control device in relation to the thermally-controlled flow cell according to an embodiment of the invention.

FIG. 6A shows a chart of air solubility versus temperature for a variety of pressures.

FIG. 6B shows a trace of the volume of air that is soluble in the volume of water as temperature increases at zero applied pressure.

FIG. 6C shows the vapor pressure of water in psig as a function of temperature.

FIG. 7A shows a photographic example of bubbles formed in a microfluidic flow cell during thermal ramping experiments according to an embodiment of the invention.

FIG. 7B shows another photographic example of bubbles formed in a microfluidic flow cell during thermal ramping experiments according to an embodiment of the invention.

FIG. 8 shows a flow cell with an On/Off output (Waste) valve with tubing as flow resistance according to an embodiment of the invention.

FIG. 9 shows an example of a control timing diagram for a 2-valve MMS system with an additional waste valve according to an embodiment of the invention.

FIG. 10 shows a flow cell with waste valve with a proportional valve according to an embodiment of the invention.

FIG. 11A shows Pressure (P) and Flow Rate (Q) without a waste valve according to an embodiment of the invention.

FIG. 11B shows an expanded view of FIG. 11A according to an embodiment of the invention.

FIG. 12A shows Pressure (P) and Flow Rate (Q) with only a waste valve according to an embodiment of the invention.

FIG. 12B shows an expanded view of FIG. 12A according to an embodiment of the invention.

FIG. 13 shows Pressure (P) and Flow Rate (Q) with waste valve and flow restrictor according to an embodiment of the invention.

FIG. 14 shows the boiling point of water as a function of pressure.

FIG. 15 shows a schematic drawing of a portion of an MMS system that includes a fixed pressure air regulator according to an embodiment of the invention.

FIG. 16 shows a schematic drawing of a portion of an MMS system that includes a programable pressure air regulator according to an embodiment of the invention.

### DESCRIPTION OF ILLUSTRATIVE EMBODIMENTS

A Microfluidic Modulation Spectroscopy (e.g. MMS) system enables measurement of a liquid analyte with a weak absorbance in a prescribed reference solution with a very high absorbance. The method includes alternatively flowing the liquid analyte and the prescribed reference solution through a fluid chamber in a liquid flow cell. The temperature of the analyte can be changed following a predetermined curve while spectral data is being collected. As the temperature of the analyte is increased, outgassing of trapped and dissolved air in the liquid analyte may be reduced, especially within the interrogation region of the flow cell, by application of a backpressure to the exit line of the flow cell. This is important for proteins, RNA, DNA, and other biomolecules because their structure and function are often temperature dependent. Further, some biological drugs need to be distributed globally and may encounter a range of ambient conditions in shipping. Details of illustrative embodiments are discussed below.

The foundation of the MMS technique is a Y junction flow cell positioned within an optical system that uses a tunable laser to measure the fluid present slightly beyond the junction of the flow path.

When studying the structure of a protein involved in biological processes, it is advantageous to measure the protein in its native formulation. As regarding proteins in animals, and humans in particular, the native formulations involve water. For example, in biopharmaceuticals, most protein solvents are aqueous with only small amounts of other buffers such as salts, sugars, and fatty acids. Thus, the majority of the solution is water.

Depending on the spectral regions of the protein that are of most interest, it is possible that the water in which the protein is dispersed may interfere with collecting the relevant structural information. Even though the presence of the water may make determining the structure of the protein more difficult, it is important to determine the structure of the protein in the water solvent, because the solvent in which the protein is dispersed affects the secondary structure and stability of the protein. Therefore, it is crucial to establish testing and measurement protocols that limit the optical interference of the background solvent (e.g., water).

In the 1580-1720 cm-1 region of the infrared (IR) portion of the spectrum, water has a very strong absorption. Liquid water has a maximum absorption of 0.12 AU (e.g., absorbance units) per micron of pathlength in this spectral region and a minimum absorption of 0.035 AU per micron. The peak absorption of liquid water is at approximately 1645 cm-1. For cell path lengths on the order of 23 um, only one laser photon out of 700 incident on the cell will pass through the fluid. Since AU is a log scale, in transmission at a measurement pathlength of 30 um this would range from 0.00021% T to 8.9% T (where % T is percent Transmission). That is, in order to measure a sample of liquid water with a measurement pathlength of 30 um would require a detector having a dynamic range of >450×. Thus, since buffers and samples are in mostly aqueous solutions, the effect of the presence of water is true for all tests. Furthermore, when trying to measure analytes that are strongly absorbing samples in larger amounts, such as 200 mg/mL, there can be another factor of 30× attenuation. Thus, the water reference solution has a very high absorbance.

In contrast, a liquid analyte such as a protein such as HEWL (Hen Egg White Lysozyme) at a concentration of 2 mg/mL will have an absorption of 0.012 AU in a 22 um pathlength cell or 0.0005 AU per micron. The protein absorption is a factor of >200× smaller than the water absorption. When measuring a protein solution such as this, any small residual error in ratioing out the water spectrum can carry over into huge errors in the protein spectrum. Thus, the MMS system can be used to measure a liquid analyte with a weak absorbance in a prescribed reference solution with a very high absorbance.

The presence of air bubbles within the optical path introduces a significant perturbation to this measurement environment. Water is an extremely strong absorber of light around 6 um wavelength. At a nominal flow cell pathlength of 24 um, water works as a 1000× absorber. Since air is transparent in infrared, having any pocket around the integration area would blow up the detector signal level. Unlike water, air has negligible IR absorption, resulting in near-complete transmission of incident IR radiation. Consequently, when an air bubble enters the measurement path, the transmitted signal can increase by several orders of magnitude relative to the baseline established by water. This abrupt change can lead to detector saturation, nonlinear response, and voltage fluctuations in systems where signal intensity is converted to an electrical output. Furthermore, as bubbles move through the optical path, transient spikes in transmission occur, introducing noise and artifacts that may be misinterpreted as analyte features.

These effects are particularly problematic in ratio-based correction schemes, where small residual errors in water subtraction can already propagate into substantial inaccuracies due to the weak absorbance of the analyte. The dynamic range required to accommodate both the near-zero transmission of water and the near-100% transmission of air often exceeds the capabilities of conventional IR detectors, leading to compromised measurement fidelity. Therefore, minimizing bubble formation through optimized fluid handling and incorporating bubble-detection algorithms into data processing workflows are critical design considerations for IR measurement systems operating in aqueous environments.

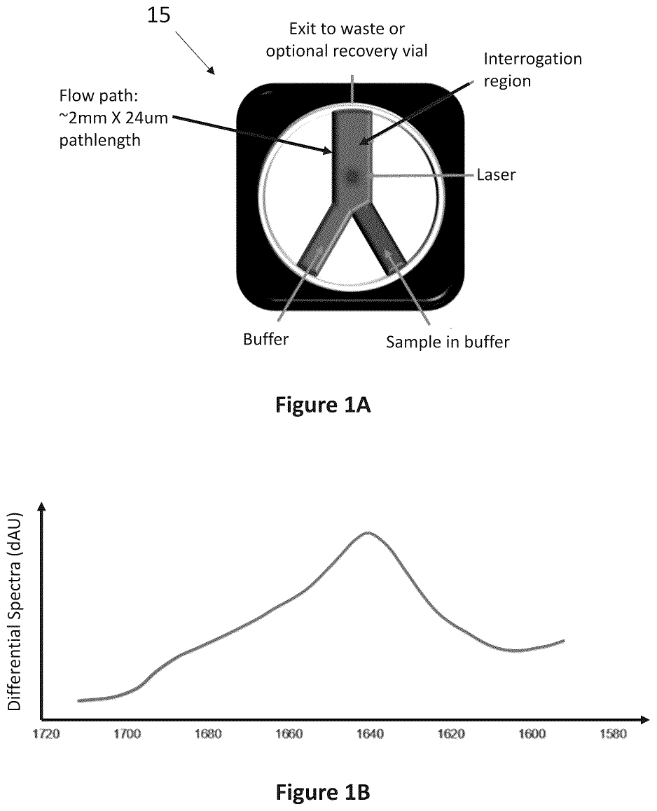

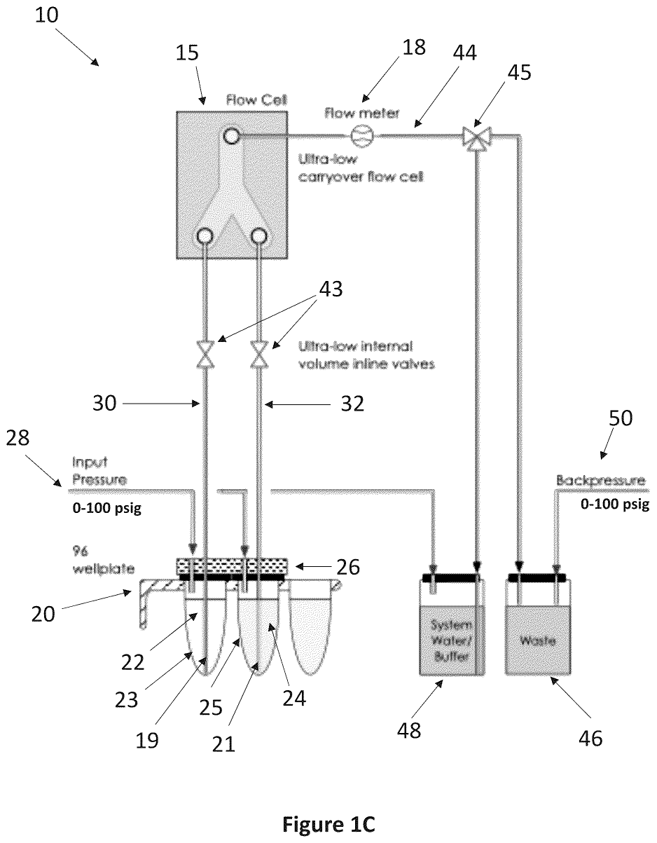

FIG. 1A shows an illustration of MMS flow cell (FIG. 1A), and FIG. 1B shows a resulting differential spectrum expressed in absorbance units, e.g. a “diff-AU” spectrum. The “sample” leg of the Y junction (shown as “sample in buffer”) gets filled with an analyte of interest, typically protein in a buffer solution or RNA in a buffer solution, and the “reference” leg of the Y junction (shown as “buffer”) gets filled with a reference fluid, such as pure buffer. Each leg of the Y junction is connected from the sample vessel (vial, 96-wellplate, bioreactor, etc.) through an inline on-off valve that can turn on or turn off flow. The headspace of the vessel is pressurized above atmospheric pressure with gas (typically air or nitrogen) to induce flow out of the vessel, toward the valve and the flow cell. The flow rate through the cell can be changed proportionally by changing back-pressure and the flow can be started or stopped by turning on or off the inline valves. By turning the valves on and off in a predetermined pattern, the system can flow one fluid at a time into the interrogation region of the flow cell in an alternating fashion, e.g., sample-reference-sample-reference. Each fluid pushes the previous fluid out of the interrogation region of the Y channel. The laser beam is incident on the interrogation region of the flow cell, transmits through the fluid in proportion to the laser wavelength and fluid absorption properties, and impinges upon a photosensitive detector which further produces an electrical signal in proportion to the transmitted light.

This description uses the term “beam path” to describe the path of an optical beam from a source to a detector, via the flow cell 15. FIG. 1A shows a transmissive configuration in which the beam path extends through the sample cell from one side to the other. This configuration is generally assumed in the remaining description. However, an alternative system may employ a reflective configuration in which the beam path is incident at one side of the sample cell and is reflected thereby to a detector arranged on the same side. As an example, the sample cell may have a sandwich type of structure of between windows made of an IR-transparent material, such as CaF₂, Si, ZnSe, ZnS, Ge, MgFl₂, BaFl₂, Sapphire (e.g., Al₂O₃), and the like. If both windows are transmissive, then the overall sample cell is transmissive. If the exit-side window is reflective, then the sample cell is reflective. However, the reflective sample cell has the disadvantage that the physical pathlength is one half of the optical pathlength, and therefore the fluid resistance is very high in comparison to the transmissive version of the sample cell.

In one embodiment, the optical source may be realized using a mid-IR laser, such as fixed frequency, or tunable QCL lasers (e.g., quantum cascade lasers). These are tuned to suitable wavelength(s) for measuring analyte(s) of interest, such as the peak of an absorbance feature chosen to minimize background interferences. The optical source (e.g., IR optical source) may be coupled to the sample cell through a matched optical filter.

Generally, measurements are differential in nature. That is, they are based on differences in optical response of samples of interest (e.g., a liquid analyte) and a reference solution (e.g., a prescribed reference solution). A prescribed reference solution may be chosen as a suitable blank, such as pure solvent, water, a gas, or other suitable reference material or mixture representative of a sample background.

The system may employ one or multiple shutters. In one example, a shutter configuration may include a flag that can be moved into and out of the beam path. In another example, the shutter may include a chopper wheel on either side of the sample cell which alternatively passes light to the detector or blocks the sample and/or reference beams prior to the sample chamber 15.

The fluid may be continuously flowed or stopped in the interrogation region of the flow cell for some period of time (less than 10 seconds) to allow for averaging of the transmitted signal. During each phase of fluid exchange (e.g., sample or reference) the laser may be swept through a plurality of wavelengths or may be held a single wavelength. The output or waste line of the flow cell is typically connected to a waste vessel that is open to ambient air and near atmospheric pressure. In this manner the system has a pressure differential from the sample vessel to the waste vessel that produces fluid flow.

In some embodiments, an MMS system 10 is configured to handle very low volumes of sample fluid and reference fluid. FIG. 1C shows a schematic diagram of a low-volume MMS system 10 that includes an ultra-low carryover flow cell 15 and ultra-low internal volume inline valves 43. The low-volume MMS system 10 also includes a flow meter 18 positioned in an exit line 44 of the flow cell 15. The flow meter 18 is mounted in an exit line 44 before a 3-way valve 45 that can direct the waste fluid in the exit line 44 to a waste fluid collector 46 or a system water and buffer collector 48. The waste fluid collector 46 may have a backpressure line 50 to provide a backing pressure to the MMS system 10.

The MMS system 10 includes a well plate 20 that includes sample wells of reference fluid 22 and sample fluid 24. A two-channel needle-based autosampler 26 is automatically positioned above of the reference fluid well 23 and sample fluid well 25. The autosampler 26 forms air-tight couplings with the reference fluid well 23 and sample fluid well 25. Pressure-controlled gas sources 28 provide a gas at a predetermined pressure (e.g., 0-100 psig) to each of the reference fluid well 23 and sample fluid well 25 to push the respective fluids through the reference fluid inlet channel 30 and the sample fluid inlet channel 32 through the ultra-low internal volume inline valves into the ultra-low carryover flow cell 42.

The gas pressure reported as psig, or pounds per square inch gauge, refers to the pressure measured relative to atmospheric pressure, whereas psi (pounds per square inch) is a general unit of pressure that can represent either absolute pressure (psia) or gauge pressure. The key distinction is that psig excludes the baseline atmospheric pressure of approximately 14.7 psig at sea level, making it ideal for practical applications where only the pressure above ambient conditions matters. In gas-based measurement instruments such as the one disclosed herein, psig is used because the system operates under controlled conditions where the pressure differential above atmospheric pressure determines flow rates and system performance. Using psig simplifies interpretation and ensures that operators focus on the effective pressure driving the process rather than accounting for atmospheric pressure in every calculation.

Returning to FIG. 1C, the sample fluid 24 and reference fluid 22 are interrogated as described above, and the fluids exit the ultra-low carryover flow cell 15 through the flow meter 18 and the valve 45 that directs the waste fluid in the exit line 44 to a waste fluid collector 46 or a system water and buffer collector 48.

In this way, the system 10 can instantaneously measure the flow rate through the flow cell 15 and adjust parameters such as fluid backing pressure, valve open time, and dwell time before data collection in order to optimize the system performance and minimize the fluid usage. The flow sensor 18 is capable of measuring flow in the 0-100 uL/sec range.

In some embodiments, an MMS system includes reverse-flow priming and flushing of the microfluidic controller from system bottles, in addition to a reversible flow meter. The reverse-flow priming and flushing can be done automatically or can be controlled by a user.

In the measurement of fluids using spectroscopic techniques, minimizing the volume consumed in the measurement may be important, because of cost and/or limited availability of analytes of interest. Techniques that reduce the volume of fluid or quantity of analyte required for the measurement may therefore be advantageous. In many spectroscopic methods, the fluidic cell that contains the fluid under test, and the measurement technique associated with the cell, are important aspects of fluid and sample minimization. Spectroscopic methods typically perform a comparison of sample and background (reference) fluids, with the ratio of the two responses being referred to herein as differential absorbance or diffAU. In many applications, it is also preferred that disposable cells be used, which may be preferable for applications requiring thermal or chemical denaturing of proteins during the testing, for example.

The patents and applications listed in Table 1 provide context on optical measurement techniques of the general type described above. The disclosure of which is incorporated herein, in its entirety, by reference.

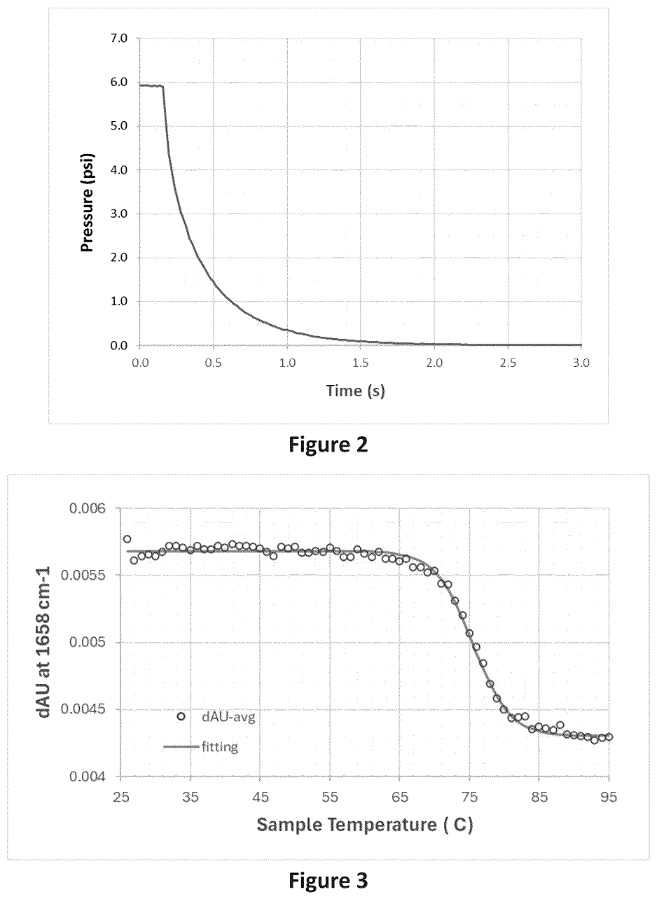

FIG. 2 shows the pressure decay of flow cell input line after pressure source is cut off by turning off the input valves 43. When the fluid has stopped flowing into the sample leg 32, the differential pressure across the flow cell will eventually decay to atmospheric pressure over a period of time that is proportional to the resistance of the tubing and other fluidic components between the inline on/off valves 43 and the waste vessel 46.

In embodiments, the MMS system enables the temperature of the analyte to change following a predetermined curve while the spectral data is being collected. This capability is important for proteins, RNA, DNA, and other biomolecules because their structure and function are often temperature dependent. Further, some biological drugs need to be distributed globally and may meet with a range of ambient conditions as they are shipped.

TABLE 1
Listing of patents and applications provide context on optical
measurement techniques of the general type described above.

| | App or Issue | Filing or Issue | |
|---|---|---|---|
| Jurisdiction | No. | Date | Title |
| USA | 14/673,015 | Mar. 30, 2015 | Fluid Analyzer with Modulation for |
| | 9,625,378 | Apr. 18, 2017 | Liquids and Gases |
| USA | 14/693,301 | Apr. 22, 2015 | Motion Modulation Fluidic Analyzer |
| | 9,377,400 | Jun. 28, 2016 | System |
| USA | 15/175,709 | Jun. 7, 2016 | Motion Modulation Fluidic Analyzer |
| | 9,778,167 | Oct. 3, 2017 | System (1^{st} Continuation of 9,377,400) |
| USA | 15/605,962 | May 26, 2017 | Microfluidic Methods and Apparatus |
| | | | for Analysis of Analyte Bearing Fluids |
| USA | 15/454,033 | Mar. 9, 2017 | Fluid Analyzer with Modulation for |
| | 10,190,969 | Jan. 29, 2019 | Liquids and Gases. (1^{st} continuation of |
| | | | 9,625,378) |
| USA | 15/714,035 | Sep. 25, 2017 | Motion Modulation Fluidic Analyzer |
| | 10,180,389 | Jan. 15, 2019 | System. (2^{nd} continuation of 9,377,400) |
| USA | 16/218,875 | Dec. 13, 2018 | Motion Modulation Fluidic Analyzer |
| | 10,746,646 | Sep. 9, 2020 | System. (3^{rd} continuation of 9,377,400) |
| USA | 18/196,946 | May 12, 2023 | Matched Optical Filter |
| USA | 19/060,150 | Feb. 21, 2025 | Infrared Transmission Cell with |
| | | | Attached Flow Sensor for Microfluidic |
| | | | Modulation Spectroscopy |

Scientists involved in the manufacture of biologic drugs need to know the temperature stability, shelf-life, and durability of their products. Typically, scientists prefer to study the analytes from 25 deg. C. up to 95 deg. C. to see the transition points where the molecule changes the most. FIG. 3 shows a sigmoidal curve showing change in differential absorption of 1 mg/ml hen egg white lysozyme in water at a fixed wavelength of 1658 cm 1. Many molecules follow a similar sigmoidal, or an “S”, curve where they are stable at room temperature, then rapidly change molecular structure at some point between 5 and 100 deg. C., and then stabilize in the “melted” state above 70-90 deg. C. Therefore, it is important to be able to change the temperature of the analyte fluid in this range. Furthermore, capturing the “flat” portions of the sigmoidal curve provide good reference points for determining an approximate “Tm” or “melt” temperature. This single temperature value can then be used as a figure of merit to evaluate how different formulations or modifications change the stability of the analyte.

While other thermal ramping instruments exist, such as differential scanning calorimetry (DSC), most can only see single-point, relative changes in chemical state. Others, such as circular dichroism, can be confounded by various buffer formulations. Based on infrared absorbance spectroscopy, MMS measures the vibrational modes of the biomolecule to reveal an absorbance profile characteristic of its underlying structure. When this is performed at multiple temperatures, each measured absorbance profile reflects the molecule's structure at that temperature.

In this way, measurements taken over a temperature ramp form a continuous series of absorbance spectra that change with temperature. The absorbance trajectory at each spectral position can then be tracked over temperature. Some spectral positions may exhibit a sigmoidal profile which indicates bistable structural behavior. For example, one spectral region corresponding to alpha-helix secondary structure may show a loss at an inflection or melt temperature of 70 C, while another region corresponding to beta sheet shows a gain in structure at the same temperature.

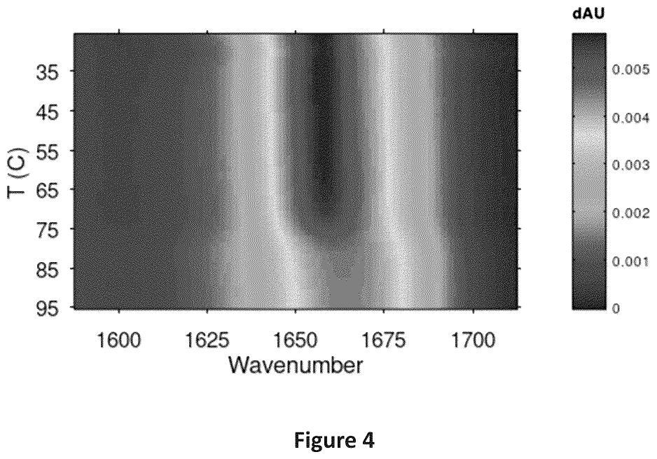

Sigmoidal fitting and analysis can be performed on different types of processed spectra, including but not limited to differential absorbance (diff AU), absolute absorbance (abs AU), second derivative, and their delta forms (i.e., change vs reference scans). With nearly 300 scans, temperature ramp data is often clearer to display and analyze as a heat map or 3-dimensional surface map. “Hot spots” on these maps then indicate the temperature and spectral locations where structural transitions occur. FIG. 4 shows a two-dimensional (2D) spectral heatmap of 1 mg/ml lysozyme in water in response to temperature change.

Precise temperature control of the flow cell must be maintained and logged over the course of the measurement. The temperature differences between sample and reference phases of MMS must be recorded and kept small enough where the temperature changes are small compared to the overall change in absorption signal. This temperature control can be achieved by embedding a temperature measurement device into the body of the flow cell or measuring the fluid temperature optically. The flow cell body can be in contact with an external heater which could be resistive or a Peltier element.

Alternatively, the heating element can be embedded in a thermally-controlled flow cell. The thermally-controlled flow cell can be removable from the system or permanently affixed. A removable version is preferable since high temperatures can cause proteins to aggregate and form clogs in the fluid channels. So, easy replacement of the thermally-controlled flow cell may be important. A typical closed-loop temperature controller such as a PID (proportional-integral-derivative) control loop can be used to control both the absolute temperature as well as the slope rate of temperature change. In one embodiment the temperature ramp rate is 1 deg. C./minute to balance the change in temperature between sample and reference phases of MMS.

Aside from precise temperature control, special considerations need to be taken in the design of a thermally-controlled flow cell that must span a large temperature range while facilitating precise microvolume fluid exchange in the interrogation area. Temperature changes cause thermal expansion and temporary or permanent deformation of materials. Many adhesives are not capable of withstanding temperatures above 80 C and may also fail due to coefficient of thermal expansion (CTE) mismatch. Tubing typically used to deliver biologic samples may also experience these material issues and small “creep” at junctions or changes in internal diameter (ID) may cause a reduction in flow rate as the temperature increases. As MMS relies on proper fluid exchange these design considerations become even more important.

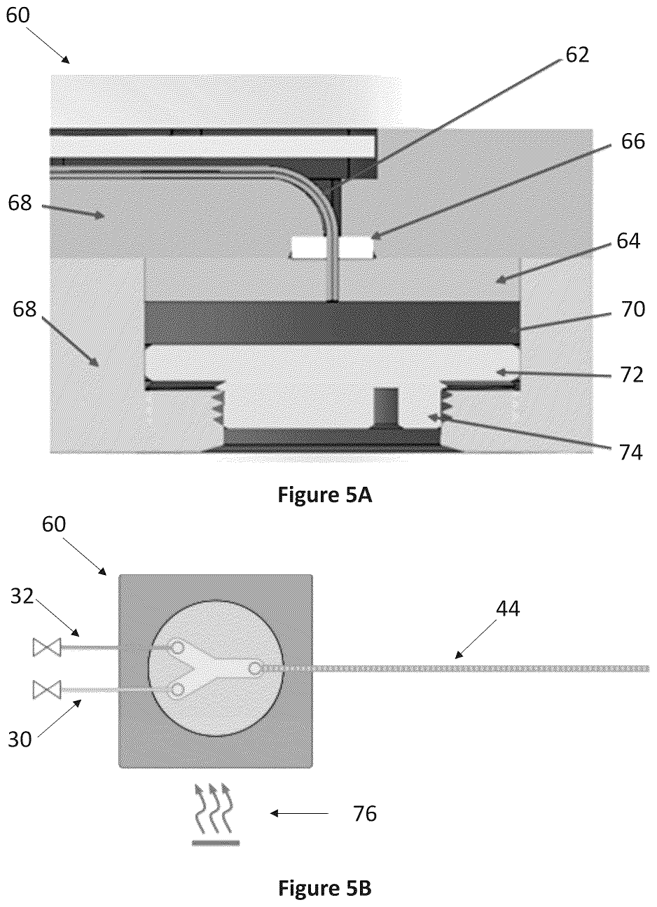

FIG. 5A shows a cross section of an embodiment of this a thermally-controlled flow cell 60. In one embodiment of this design, higher temperature small inside diameter (e.g., ID) PEEK tubing 62 is inserted in a slip-fit fashion through a drilled hole in the thermally-controlled flow cell's infrared transparent Window #1 64. FIG. 5A shows a cross section of one embodiment of this design where the tubing 62 is flush with the fluid side of Window #1 64 and positioned against Window #2 70. To provide a seal, an annular gasket 66 is placed concentric with and around the tube 62 and seals the tubing against the outside of the Window #2 70 when compressed by the housing 68 of the thermally-controlled flow cell 60, which also compresses the windows (e.g., Window #1 64 and Window #2 70) and prevents expansion from pressure. The entrance and exit tubing can be in close contact with the thermally conductive housing 68 which is temperature controlled as mentioned above. This close contact allows for thermal transfer to occur between the thermally-conductive flow cell housing 68 and the tubing 62. Furthermore, the tubing 62 can be adjusted to be either flush with the fluid-side surface of Window #1 64 or pulled back to create a pre-heating reservoir in the drill hole. The preheating reservoir allows the fluid to dwell at the higher temperature before reaching the interrogation area which can be important for samples with higher heat capacity. A load spacer 72 provides a cushion between a retaining ring 74 and Window #2 70.

In some embodiments of this design, thermal control device 76 may be incorporated into the thermally-controlled flow cell 60. FIG. 5B shows a schematic drawing of the thermal control device 76 in relation to the thermally-controlled flow cell 60. The thermal control device 76 may be an external heater which could be resistive or a Peltier element, and it may include a closed-loop temperature controller such as a PID control loop, as described above.

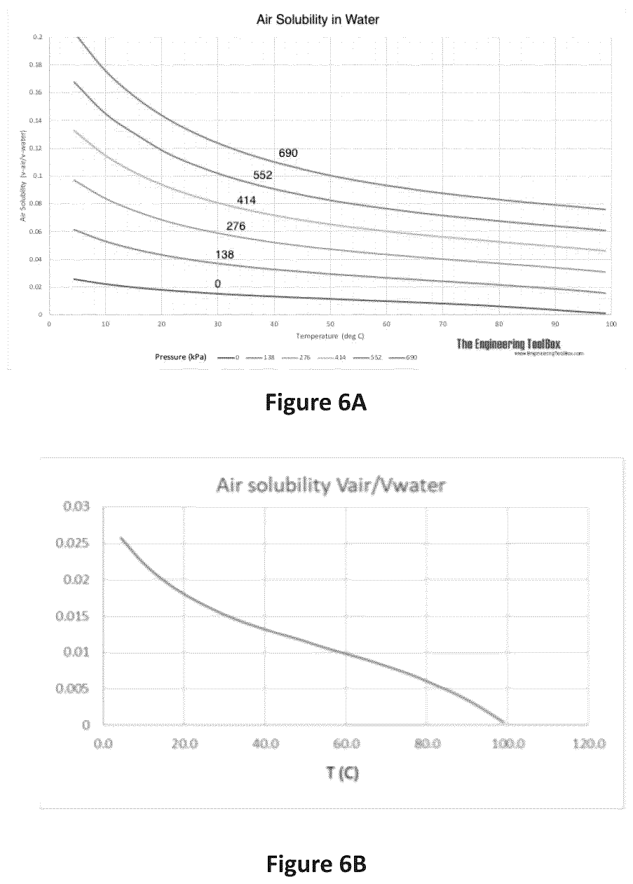

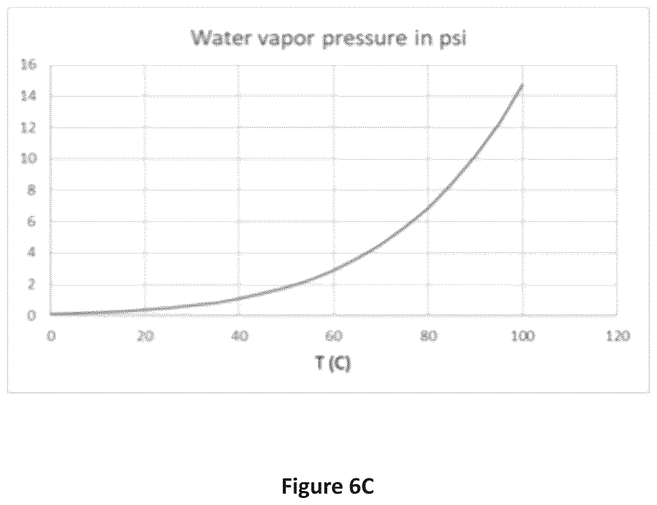

A major challenge in raising the temperature of an aqueous solution to near its boiling point in a microfluidic device is bubble generation, which often interferes with critical measurements. Bubbles formed due to elevated temperature have two main sources. One is degassing of dissolved air because the solubility of air in water decreases with temperature, as shown in FIGS. 6A and 6B. FIG. 6A shows a chart of air solubility versus temperature for a variety of pressures. As the pressure in the pressure vessel is raised from 0 kPa to 690 kPa, the volume of air that is soluble in the volume of water increases. FIG. 6B shows a higher resolution trace of the volume of air that is soluble in the volume of water as temperature increases at zero applied pressure.

A second source of air bubbles is due to water vapor feeding into existing gas bubbles as the solution is heated up above 80 C where more water molecules gain enough energy to escape from the liquid phase into the gas phase. FIG. 6C shows the vapor pressure of water in psig (e.g., pounds per square inch gauge) as a function of temperature.

When liquid water at room temperature is heated, air bubbles start to form since the water cannot retain the dissolved air (mostly nitrogen with oxygen) any longer. As the water continues to be heated, more bubbles (water vapor) form as the vapor pressure reaches ˜15 psig at 100° C., the normal boiling point of water at sea level. This illustrates that at higher water temperatures the likelihood of bubble formation increases significantly at temperatures greater than 60 C.

For example, when the water is at 60 C, at sea level, with no additional backpressure, it retains up to 1% of its volume in air. So, if a MMS measurement is initiated at 5 deg C. or higher, >0.5% of total volume worth of air has been released as air. By pressurizing the whole line by >3 psig, the air solubility can be increased to be close to that of when it is at room temperature, so no air or bubbles are released.

Similar to the challenges with heating water, there are major challenges in heating organic solvents in microfluidic systems to elevated temperatures without bubble formation. Maintaining pressure stability is critical for accurate measurements and flow control. Unlike aqueous buffer solutions, organic solvents are increasingly used in peptide drug development because many peptides exhibit limited solubility in water. Common solvents for this purpose include dimethyl sulfoxide (DMSO), methanol, and acetonitrile.

The boiling points of these solvents at ambient pressure vary significantly. For example, the boiling points for important solvents are as follows: DMSO: 189° C.; Methanol: 64.7° C.; and Acetonitrile: 81.6° C.

When heating these solvents to 100° C., bubble formation becomes a concern unless additional pressure is applied. For methanol, a pressure of approximately 38.1 psig is required to suppress boiling, while acetonitrile requires about 25 psig. In contrast, water at 100° C. only needs an additional 15 psig to prevent bubble formation, making aqueous systems inherently easier to manage under thermal stress.

Thus, solvent selection impacts thermal management strategies-lower boiling point solvents demand higher pressurization for bubble suppression when taking the system to 100 deg. C. System design must account for pressure limits and safety margins, especially when transitioning from aqueous buffers to organic solvents in peptide drug workflows.

The formation of air bubbles in the microfluidic flow cell can impede both optical measurements and fluid control, resulting in poor system performance. For example, unexpected and non-ideal flow rate versus time traces may be an indication of having an air bubble in the flow cell at some point. An air bubble can affect the flow rate by expanding and contracting. Air bubbles can work as soft springs between rigid components (incompressible test fluid) that overshoot whenever either valve opens or closes. The presence of air bubbles in the fluid lines is typically identified as large spikes up or down in the flow rate versus time curves. An unexpected and non-ideal flow rate versus time trace may also indicate viscosity differences between fluids, and indicate temperature variations.

Another complication from having air bubbles present, is that since pressure-back modulation is used, having a bubble anywhere in line would make flow movement not deterministic. That is, because unlike incompressible liquid (fluid moves as soon as the valve is open and stops as soon as the valve is closed), air bubbles work as cushion layers to slow the flow down.

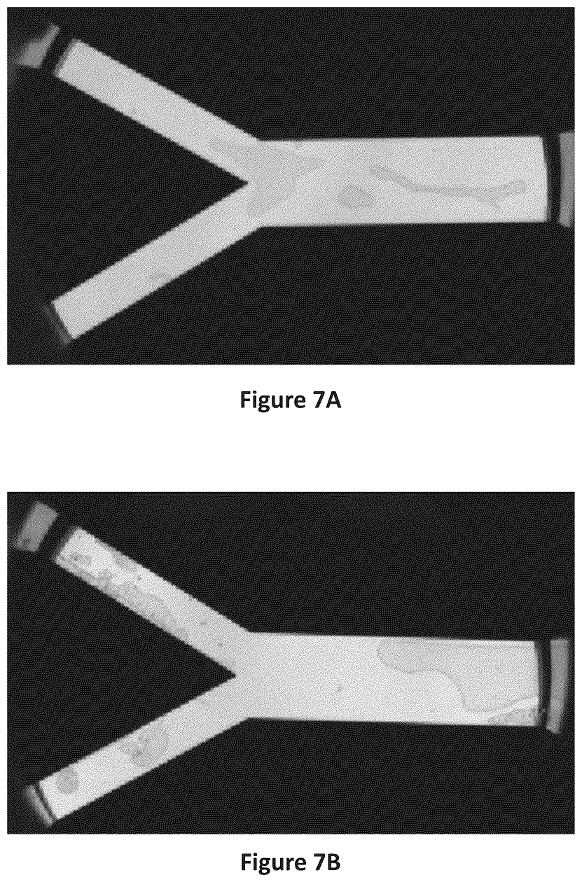

FIGS. 7A and 7B show two photographic examples of bubbles formed in the microfluidic flow cell during thermal ramping experiments. Often, in high aspect ratio microfluidic channels (channel width to thickness ratio) like used in MMS, and at macro-micro interfaces where there are large flow path dimensional changes, air bubbles can become trapped and difficult to clear out by normal means. In a flowing system (even stop-start flow), the bubbles may get trapped in a thin pathlength flow cell like what is needed for IR transmission. Therefore, it is imperative to avoid the occurrence of gas bubbles in the flow cell despite the rapid temperature change as an analyte is moved from an ambient sample vessel to the higher temperature infrared flow cell.

Protein/antibody or DNA/RNA samples are precious and expensive due to the cost of synthesizing, isolation, and purification. Therefore, it is also important to use only very small (microliter/microgram) volumes in the measurements. Also, it is often desirable to have fluid flow move in both directions of the flow cell (from sample/reference to waste as well as from waste to sample/reference). This capability allows priming and flushing of the cell in a bimodal fashion, improving speed and convenience for the user.

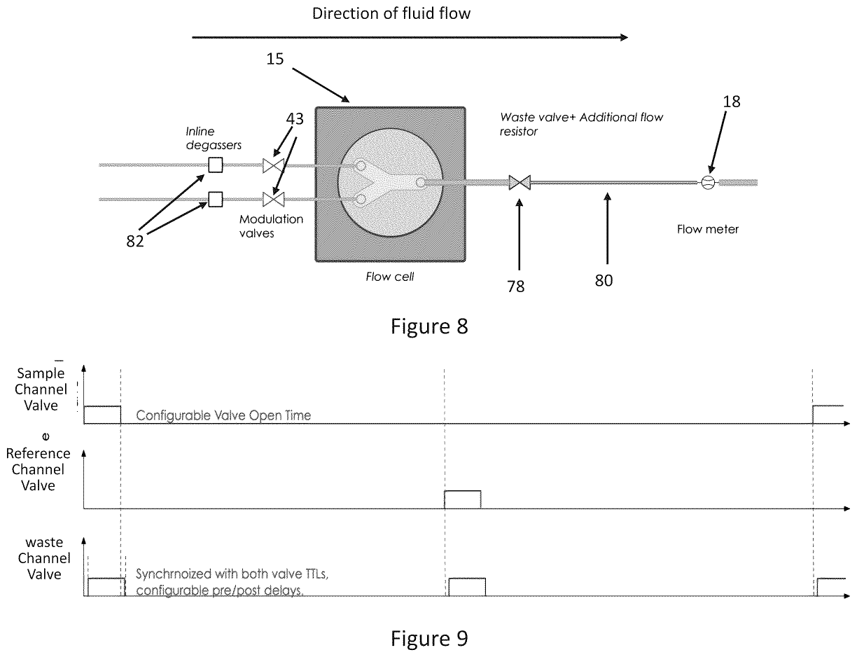

In some embodiments, an additional valve or system of valves can be placed in the “waste” line at an output of the flow cell. FIG. 8 shows a schematic drawing of a portion of an MMS system that includes a “waste” valve 78. The waste valve 78 can then be coordinated with the existing input valves 43 to “trap” a pressure higher than atmosphere in the infrared flow cell as shown in FIG. 8. FIG. 8 shows an On/Off output (Waste) valve 78 with tubing 80 as flow resistance. Inline degassers (e.g., gas-permeable membranes) 82 are shown proceeding the input valves (e.g., modulation valves) 43.

In embodiments, the term inline degasser is used interchangeably with gas-permeable membrane. An inline degasser and a gas-permeable membrane both remove dissolved gases from liquids, but they operate differently. An inline degasser uses a vacuum or sweep gas in a dedicated chamber to rapidly strip gases from the liquid, making it ideal for high-flow applications where speed is critical. In contrast, a gas-permeable membrane relies on selective diffusion through a semi-permeable material, allowing gases to pass while retaining the liquid. This method is more compact and gentle, reducing solvent loss, but it is slower and better suited for continuous low-flow processes. The choice between the two depends on factors such as flow rate, system complexity, temperature, and sensitivity to solvent evaporation. In embodiments, a gas-permeable membrane may be incorporated into an MMS system following the flow cell to provide backpressure to the exit from the flow cell.

The higher pressure is held during the stopped phase of fluid flow and while the laser is incident on the flow cell and the detector is collecting the transmitted light. For this to be effective, the waste valve 78 must be closed while the input valves 43 are still open and pressure from the air pressure-back flow system is being applied. After the waste valve 78 is closed, flow is stopped, and the input valves 43 can then be closed trapping pressure in the cell 15. Note that different valve types may be used for sample, reference, and waste so there may need to be phase compensation for the differences in mechanical actuation times. For example, in one embodiment rotary valves are used for the input valves where extremely low volume and low fluid carryover are important and a solenoid valve is used for the waste valve where speed, size, and power consumption are more important. Rotary valves are slower than solenoid valves so the actuation times must be compensated for by the electrical control circuit/firmware in order to prevent the waste valve 78 from closing after the input valves 43.

In some embodiments control of the electrical signals to the valves is controlled by a microcontroller or other computer with general purpose output pins and a drive circuit.

FIG. 9 shows an example of a control timing diagram for a 2-valve MMS system with an additional waste valve 78. Configurable pre/post phase delays can be added to synchronize different valves that have different mechanical actuation times. The waste valve 78 can be synchronized to open only when either input valve 43 is open. This helps to keep the entire fluid path pressurized to suppress bubbles when the fluid is not in motion. When the fluid is in motion, a passive resistor, such as a narrow tube, can be used to add additional fluid resistance and keep the flow cell pressurized to suppress bubbles.

During the MMS cycle described above, when the waste valve 78 is opened the differential pressure across the flow cell will eventually decay to ambient pressure as fluid flows toward the output waste vessel 46. The timing of this decaying pressure can be slowed by increasing the fluid resistance of the fluid tubing/circuit from the output of the cell to the waste vessel 46. Additional flow resistance/restriction, as shown in FIG. 8, can be precisely tailored to achieve a “slow enough” decay rate such that pressure effectively stays in the cell long enough for the fluid exchange to happen without a significant transient pressure drop.

In one embodiment, this additional fluid resistance is simply a length of small ID (inside diameter) rigid tubing. The use of the small ID rigid tubing 80 is illustrated in FIG. 8. A length of tubing 80 used to increase the flow impedance has the advantage of being inexpensive and simple to implement (no additional valve to synchronize), however this approach has the disadvantage of being a fixed resistance that cannot be automatically changed for different conditions (such as priming and flushing operations). Also, due to manufacturing tolerances, implementing small ID tubing becomes challenging at manufacturing scales, because variation of ID, due to allowable tolerances, means that control of the length of the tube becomes necessary to get the desired backpressure.

The restriction is the tubing may include a sufficiently small inner diameter such that it adds a prescribed and significant resistance to the flow path. In some embodiments, the inner diameter of the tubing may range from 1.0 mils to 10 mils, where one mil equals 0.001 inches. This range corresponds to approximately 0.001 to 0.010 inches, which is about 25.4 microns to 254 microns. This is roughly 0.0254 millimeters to 0.254 millimeters, or 0.00254 centimeters to 0.0254 centimeters. Such a dimensional range provides a controlled restriction that can influence fluid dynamics, including pressure drop and flow rate, within the system.

A further iteration of this embodiment places larger ID tubing with an additional on/off valve in parallel with the small ID. When the valve is open the total fluid resistance is reduced, and higher flow rates or higher fluid viscosity can be achieved. When the valve is closed only the small ID tubing is in the fluid circuit and the slow decay rate can be achieved.

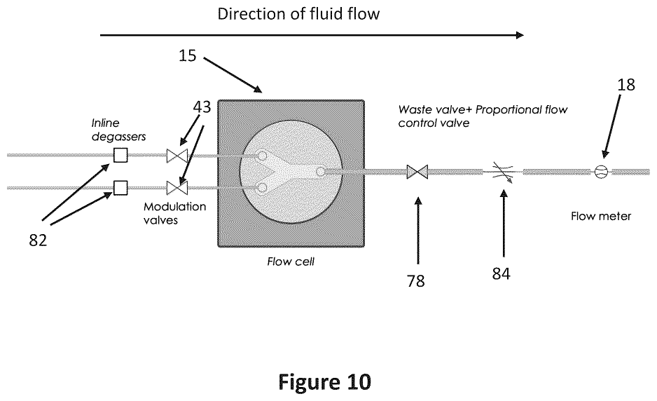

Another embodiment shown in FIG. 10 uses a proportional valve system which can provide a variable flow resistance in proportion to an input analog electrical signal. FIG. 10 shows a waste valve 78 with a proportional valve 84. While somewhat more expensive, this embodiment allows for the pressure decay rate to be precisely tailored for different conditions and be completely removed for other operations such as priming and flushing.

In another embodiment, a fast action on/off valve can be used as the waste valve and can act in a similar manner to a proportional valve by applying a pulse width modulated signal which can control the flow in proportion to the duty cycle of the applied electrical signal. Some commercially available solenoid valves are capable of modulating up to 1000 Hz which is faster than the fluid system can respond and therefore only the average of the waveform is observed with no undesirable pulsing. This embodiment uses a single component and provides flexibility in controlling the flow rate resistance like the proportional valve.

In another embodiment, the headspace of the waste vessel is pressurized with air at a pressure higher than atmosphere but lower than the pressure of the sample vessel. This creates a lower differential pressure that acts similarly to a flow restriction and holds higher than atmospheric pressure in the flow cell, reducing the likelihood of degassing. Additionally, the pressure in the waste vessel headspace can be changed to achieve the decay rate desired for different conditions.

When the head space of the waste vessel is held at pressures higher than atmosphere, this embodiment reduces the chance of air bubbles forming in the flow cell. It also has the advantage of maintaining a fixed, known pressure in the flow cell during sample and reference measurement phases as opposed to other embodiments that may have different pressures due to the need to move fluids of different viscosities. This embodiment can be simplified using a 3-way valve to set the headspace pressure of the waste vessel 46 to either a high pressure (typically 0-100 psig) or vent to atmosphere for non-thermally ramped conditions. Using an inexpensive and commonly available fixed air pressure regulator, the pressure in the headspace can be set to the higher than ambient pressure of the waste vessel. The 3-way valve may be used to vent the head space of the waste vessel to relieve pressure within the waste vessel 46.

In an alternative embodiment, a precision electronic pressure controller may be used for this purpose. This embodiment also has the advantage that it could eliminate the need for an inline degasser if the differential pressure held across the flow cell is high enough to eliminate degassing at high temperatures.

In addition to the waste valve and flow restriction mechanisms, the use and positioning of inline degassers play a crucial role in minimizing air bubble formation within the flow cell. Several well-known, commercially available inline degasser designs can be considered. Membrane-style degassers feature a gas-permeable membrane that covers part of the fluid channel, with a vacuum chamber on the opposite side to extract dissolved gases from the fluid as it moves across the membrane. Similarly, tubular degassers use gas-permeable tubing housed inside a vacuum chamber to achieve the same effect. While both types of degassers are effective, their placement within the system is critical. To ensure precise fluid control, degassers should be installed before the input valves. Placing them after the input valves can introduce irregularities in fluid flow due to the compliance of the membrane or thin-walled tubing, which can react to valve operations.

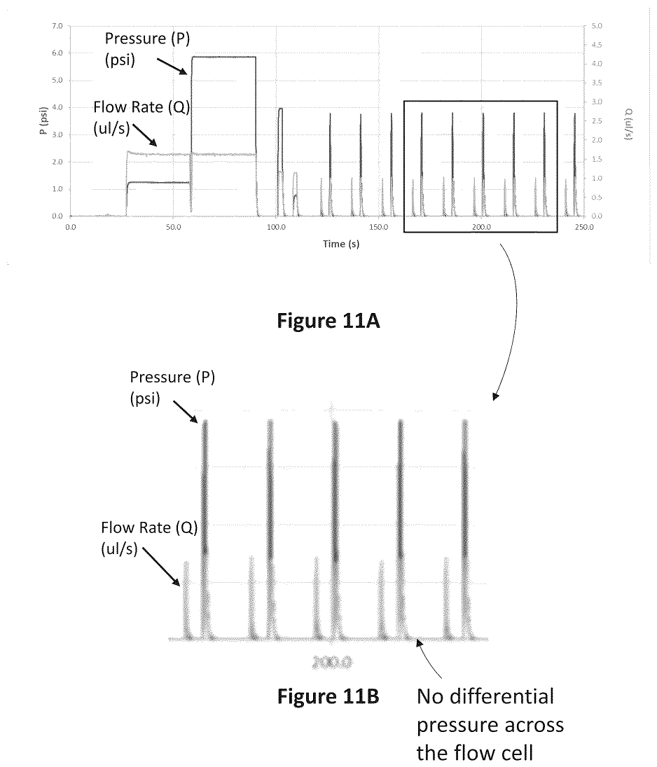

FIG. 11A shows Pressure (P) and Flow Rate (Q) as a function of time for an MMS system without a waste valve, as illustrated in FIG. 1C. FIG. 11A shows measurements of the pressure and flow rate of the output of the MMS flow cell without the addition of the waste valve and flow restriction.

FIG. 11B shows an expanded view of FIG. 11A. It can be noted that pressure is high while the input valve is open and then rapidly decays to zero after the input valve closes, as is indicated by the arrow, resulting in no differential pressure across the flow cell.

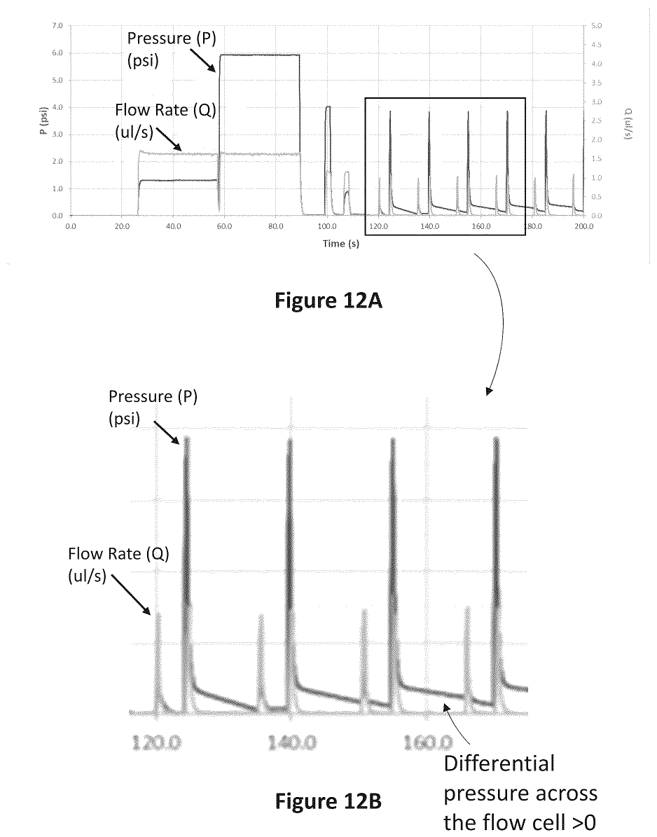

FIG. 12A shows Pressure (P) and Flow Rate (Q) as a function of time for an MMS system with only a waste valve 78. FIG. 12 shows the same conditions but with the addition of a waste valve 78, but no additional flow resistance. In this example, pressure is kept higher than zero and would gradually continue to grow over time, however the build up is slower than would be desired.

FIG. 12B shows an expanded view of FIG. 12A. It can be noted that pressure is high while the input valve is open, but, in contrast to the system without the additional flow resistance, the pressure remains elevated greater than 0 psig even after the input valve closes, as is indicated by the arrow.

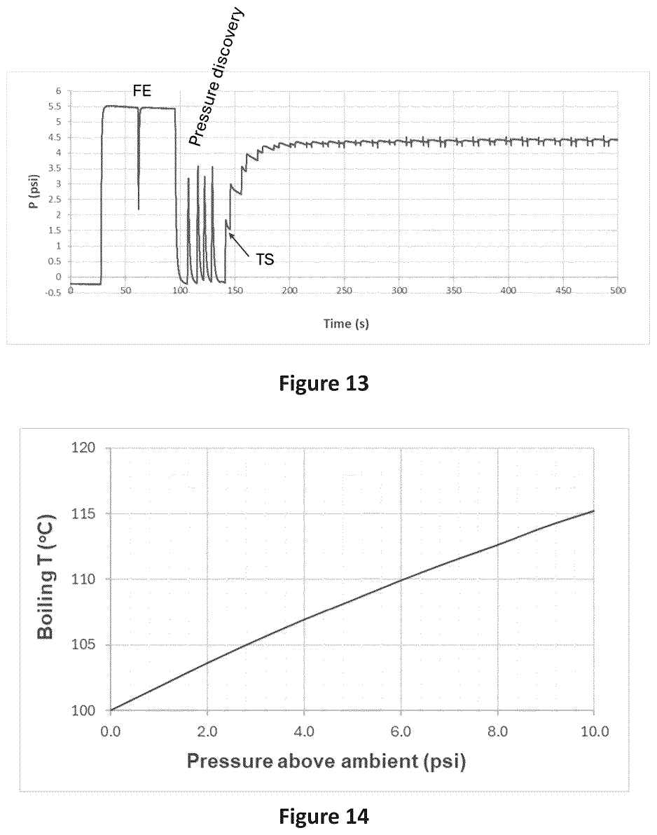

FIG. 13 shows Pressure (P) versus time for an MMS system with a waste valve 78 and flow restrictor 80, as illustrated in FIG. 8. FIG. 13 shows the results of the addition of both the waste valve 78 and the flow restrictor 78 which, in this case, is a segment of small ID tubing. Note that the output pressure P builds quickly and is kept above 4 psig for the duration of the measurement process, after a period of pressure discovery.

Note that pressure is gradually built up and maintained (in this example at ˜4 psig/27 kPa) above atmospheric pressure (14.7 psig or 101 kPa). The amount of air that can remain soluble in water increases with pressure according to Henry's Law which states that the solubility of a given gas in a liquid is directly proportional to its partial pressure above the liquid. In addition, water molecules in the liquid will need higher energy to escape into the vapor phase at higher pressure, resulting in increased boiling temperature, as shown in FIG. 14.

FIG. 14 shows the boiling point of water as a function of pressure. So, this additional pressure helps to reduce gas bubble formation and can be used to offset the tendency of gas bubbles to be released at higher temperatures. Additionally, the higher operating pressure of the fluid in the flow cell reduces the size of any bubbles that still manage to form in the flow channels. While this does not entirely prevent bubbles from intermittently interfering with spectral measurements, the higher pressure does facilitate the movement of these smaller bubbles out of the channel region, allowing proper measurements to continue.

Referring back to FIG. 1C, the MMS system 10 includes a source of backpressure 50 that is provided to the waste vessel 46. Providing backpressure to the system is important to reducing bubble formation. For example, when the water is at 60 deg. C., at sea level, with no additional backpressure, it retains up to 1% of its volume in air. So, if a measurement run was started at room temperature, >0.5% of total volume worth of air has been released as air. By pressurizing the whole line by >3 psig, its air solubility can be increased to close to that of when it is at room temperature, so no air or bubbles are released. The amount of vapor pressure and necessary backpressure to suppress bubble formation varies depending on solutions to be used.

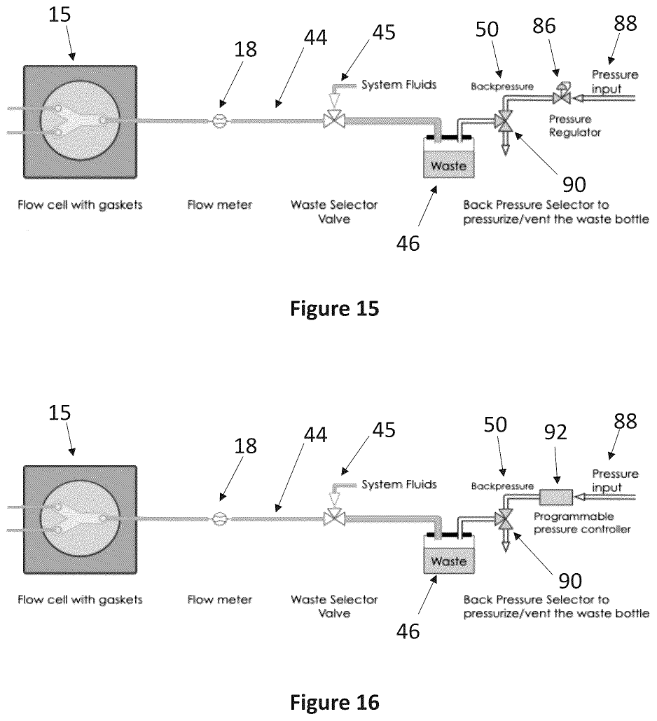

When a test run is to be operated with increasing the flow cell (or liquid) temperature up to 95 deg. C., the vapor pressure of the aqueous sample rises to ˜14 psig. In this case, a fixed air regulator may be set to a backpressure of 17 psig (with an additional 20% headroom) to suppress bubble formation. The 17 psig provides a backpressure about 3 psig greater than the vapor pressure at 95 deg. C. The temperature of the flow cell can be increased further by increasing the provided backpressure. FIG. 15 shows a schematic drawing of a portion of an MMS system that includes a fixed pressure air regulator 86 inline between a pressure input source 88 and the backpressure input line 50 to the waste vessel 46. A 3-way backpressure selector 90 is provided in the backpressure input line 50 to either pressurize or vent the waste vessel 46.

In some embodiments, a fixed pressure air regulator 86 is provided inline with a single pressure source 88 input to each instrument. The presence of the fixed pressure air regulator 86 may limit the dynamic range of MMS system. For example, the system only needs >3 psig backpressure to suppress bubble formation at near room temperature. However, even though the measurements may be taken at room temperature, the fixed pressure air regulator is still using the same 17 psig backpressure, so an available pressure dynamic range would be about 13 psig (30 psig input pressure-17 psig backpressure=13 psig.) In other words, the maximum viscosity of sample fluids that can be supported in the MMS system that includes a 17 psig backpressure would be reduced by half if all other conditions are the same (i.e. the same valve open time).

This highlights a tradeoff between a limited dynamic range of pressures available for bubble suppression and the total amount of pressure available to push fluids. In other words, if there's no backpressure, we can utilize the whole input pressure range. With backpressure, however, it would be input pressure-backpressure, so it is not possible to push as viscous fluids.

In some embodiments, the tradeoff between the limited dynamic range of pressures available for bubble suppression and the amount of pressure available to push viscous samples may be addressed by the inclusion of a programable pressure air regulator in the place of a fixed pressure air regulator.

FIG. 16 shows a schematic drawing of a portion of an MMS system that includes a programable pressure air regulator 92 inline between a pressure input source 88 and the backpressure input line 50 to the waste vessel 46. A 3-way backpressure selector 90 is provided in the backpressure input line 50 to either pressure or vent the waste vessel 46. The programable pressure air regulator 92 may operate as a part of a closed-loop pressure control system that is controlled by a system controller. The system controller may receive signals from pressure gauges, thermal sensors, valves, pressure input devices, and the like. The system controller may be programable or may be operated manually by a user, or a combination of both.

In embodiments, the regulator setpoint may be fixed, binary (either at a higher set point or at atmosphere), or dynamic (digitally settable from 0 psig to 100 psig.

The MMS systems described herein address a similar problem of air bubbles being released from solution that can be seen in high performance liquid chromatography (e.g., HPLC) systems where the analytes are under high pressure as they move through the column and experience a large pressure drop as the fluid enters the optical flow cell. A common method for reducing the occurrence of air bubbles in this case is by placing a check valve or mechanical back-pressure regulator after the flow cell that keeps the liquid pressure high until the analyte has passed through the cell.

This mechanical back-pressure regulator is a common solution for HPLC instruments for the same purpose of bubble suppression. An example is an instrument where there is a backpressure air regulator installed inline before the waste vessel, with the waste vessel having an open end. The mechanical back-pressure regulator works well when there is a large (and stable) pressure and nearly continuous flow. This example system with a pump used in HPLC produces about 2000 psig input pressure in the upstream continuously, having a 50 psig backpressure regulator. This arrangement works in this example because such a large headroom (2000−50=1950 psig) effectively eliminates any gap or ripples in upstream pressure.

It is surprising that the incorporation of a mechanical backpressure regulator, like the ones used in HPLC systems, would render the MMS system of this disclosure inoperable. That is because embodiments of the instrument described herein use a pressure-driven fluid flow scheme with a much lower pressure than used in HPLC (0-100 psig versus >1000 psig for HPLC.) The fluid flow stops and starts in the disclosed “stop flow” MMS. This requires stable upstream pressure and constant backpressure to suppress bubbles. For pressure-driven modulation, its pressure dynamic range would be far smaller as it does not use pumps but works from a regulated pressure source (air, N₂, etc.). The disclosed MMS system can operate with up to about 100 psig for the input pressure. The practical reason that the disclosed system is limited to about 100 psig for the input pressure, is that the flow cell structure changes with respect to input pressure, because mechanical deformation from the higher pressures causes a longer pathlength. Typical HPLC pressures exceed 1000-2000 psig, because typical HPLD systems use a mechanical pump to provide the high pressures required.

Another surprising reason that incorporation of a mechanical backpressure regulator, like the ones used in HPLC systems, would render the MMS system of this disclosure inoperable is because in some embodiments, an MMS system includes reverse-flow priming and flushing of the microfluidic controller from system bottles, in addition to a reversable flow meter. Another disadvantage of the mechanical backpressure air regulator like used on HPLC is that it works like a check valve, allowing fluid flow in only one direction. The disclosed system does priming and flushing operations in “reverse” flow which simplifies the users interaction with the system. For example, when the system is primed, fluid flows from the system water bottle in the reverse direction of normal analyte flow. This allows a large water bottle to be used under pressure-backed flow and makes priming and flushing of the fluid path quick and easy. A mechanical backpressure air regulator like found on HPLC systems would not allow fluid flow in both directions and would therefore restrict the system from this operation. In contrast, the invented backpressure system can be turned off or dynamically adjusted as needed to allow fluid to flow both directions.

What is claimed:

1. A system to measure a liquid analyte with a weak absorbance in a prescribed reference solution with a very high absorbance, the system comprising:
a liquid flow cell;
a vessel following the liquid flow cell, the vessel having airspace above a liquid occupying the vessel; and
an air regulator following the flow cell, the air regulator configured to provide a back pressure to the liquid flow cell,
wherein the system is configured to receive liquid injected at an injection site before the one or more shutoff valves, the system configured to move the injected liquid through the system under pressure provided at the injection site.

2. The system of claim 1, wherein:
the liquid flow cell transmits infrared light; and
the system further comprising:
an infrared light source, the infrared light source configured to provide infrared light to be transmitted through the liquid flow cell; and
a system controller.

3. The system of claim 2, wherein:
the air regulator is configured to provide a fixed amount of pressure; or
the air regulator is configured to be dynamically adjusted by the system controller.

4. The system of claim 3, wherein the dynamically-adjusted air regulator provides a backpressure on the flow cell between 0 psig and 100 psig inclusive.

5. The system of claim 4, wherein the dynamically-adjusted air regulator is controlled by a dynamic pressure controller.

6. The system of claim 3, wherein the fixed pressure air regulator provides a backpressure on the flow cell that is settable between 0 psig and 100 psig inclusive.

7. The system of claim 6, wherein the fixed pressure air regulator is configured to be controlled by a closed-loop pressure control system to measure and hold the pressure at the set pressure.

8. The system of claim 7, wherein the closed-loop pressure control system is configured to be controlled by the system.

9. The system of claim 1, further comprising:
at least one inline gas-permeable membrane following the liquid flow cell.

10. A method to measure a liquid analyte with a weak absorbance in a prescribed reference solution with a very high absorbance, comprising:
alternatively flowing the liquid analyte and the prescribed reference solution through a fluid chamber in a liquid flow cell;
restricting flow of an output of the liquid flow cell along tubing carrying the output of the liquid flow cell;
emitting an infrared (IR) light from an IR light source, the IR light being filtered through an optical filter;
transmitting the filtered IR light through a sample cell in the fluid chamber to produce a chamber signal; and
using a detector having an optical range to detect the chamber signal.

11. The method of claim 10, further comprising:
directing the output of the flow cell through a restriction in the tubing.

12. The method of claim 11, wherein the restriction the tubing may include a sufficiently small inner diameter such that it adds a prescribed and significant resistance to the flow path.

13. The method of claim 11, wherein the restriction in the tubing comprises a proportional flow control valve.

14. The method of claim 12, wherein inner diameter of the tubing is between 1.0 microns and 10 microns inclusive.

15. The method of claim 12, wherein a length of the tubing is between 1 centimeter and 100 centimeters.

16. The method of claim 10, further comprising:
directing the output of the flow cell through a virtual restriction.

17. The method of claim 16, wherein the virtual restriction comprises modulating the waste valve duty cycle.

18. The method claim 8, wherein the duty cycle is between 1 HZ and 1000 Hz inclusive.

19. The method of claim 10, further comprising:
controlling a temperature of the liquid flow cell.

20. The method of claim 19, wherein the temperature of the liquid flow cell is controlled between about 5 deg. C. and about 100 deg. C. inclusive.

21. The method of claim 19, wherein the temperature is controlled in a ramp rate of between about 0.1 deg. C./minute and 10 deg./min inclusive.

22. The method of claim 21, wherein the temperature ramp rate is about 1 deg C./minute.

23. A system to measure a liquid analyte with a weak absorbance in a prescribed reference solution with a very high absorbance, the system comprising:
a tunable optical laser source configured to emit coherent light across a range of wavelengths;
a liquid flow cell having a sample chamber with a chamber window, the liquid flow cell configured to alternatively receive the liquid analyte and the prescribed reference solution;
a detector having an optical range to detect the chamber signal; and
a restriction along tubing configured to carry output of the liquid flow cell.

24. The system of claim 23, further comprising:
a thermal control device configured to control a temperature of the liquid in the liquid flow cell.

25. The system of claim 23, wherein the restriction is the tubing may include a sufficiently small inner diameter such that it adds a prescribed and significant resistance to the flow path.

26. The system of claim 24, wherein the restriction in the tubing comprises a proportional flow control valve.

27. The system of claim 23, further comprising:
an optical filter positioned between the optical laser source and the liquid flow cell, the optical filter configured to filter the emitted coherent light prior to being transmitted through the chamber window of the sample chamber to produce a chamber signal.

28. A method to measure a liquid analyte with a weak absorbance in a prescribed reference solution with a very high absorbance, comprising:
alternatively flowing the liquid analyte and the prescribed reference solution through a fluid chamber in a liquid flow cell to a waste vessel;
pressurizing a headspace of the waste vessel above the waste liquid analyte and prescribed reference solution;
emitting an infrared (IR) light from an IR light source, the IR light being filtered through an optical filter;
transmitting the filtered IR light through a sample cell in the fluid chamber to produce a chamber signal; and
using a detector having an optical range to detect the chamber signal.

29. The method of claim 28, further comprising:
flowing the liquid analyte and the prescribed reference solution through a 3-way valve positioned between the fluid chamber in a liquid flow cell and the waste vessel.

30. The method of claim 28, further comprising:
pressurizing the headspace of the waste vessel through a 3-way valve attached to and in liquid communication with the waste vessel.

31. The method of claim 28, further comprising:
venting the headspace of the waste vessel through a 3-way valve attached to and in liquid communication with the waste vessel.

32. The method of claim 28, wherein pressurizing the headspace comprises holding a headspace pressure of greater than atmospheric pressure.

33. The method of innovation 32, wherein the headspace pressure is held at a pressure of between 0 psig and 100 psig inclusive.
